(19) United States
(12) Patent Application Publication
(10) Pub. No.: US 2026/0289001 A1
(43) Pub. Date: Sep. 24, 2026

(54) INTENTIONAL TRANSACTION FLOW DOWNGRADE TO SUPPORT CONFIDENTIAL INFORMATION EXCHANGE

(71) Applicant: Arm Limited, Cambridge (GB)

(72) Inventors: Benjamin Robert Hicks, Newmarket (GB); Jason Parker, Sheffield (GB); Bruce James Mathewson, Papworth Everard (GB); Jamshed Jalal, Austin, TX (US)

(73) Assignee: Arm Limited, Cambridge (GB)

(21) Appl. No.: 19/084,076

(22) Filed: Mar. 19, 2025

(51) Int. Cl. G06F 21/62

(52) U.S. Cl. CPC G06F 21/6245

(57) ABSTRACT

An apparatus and method for responsively downgrading a forwarding snoop flow of the incoming snoop to a non-forwarding snoop flow. A snoopee agent of a data processing network that is configured to respond to detection of a memory encryption context identification (MECID) mismatch between a MECID of an incoming snoop and a locally cached MECID of the snoopee agent and responsively downgrade a forwarding snoop flow of the incoming snoop to a non-forwarding snoop flow.

### BACKGROUND

The complexity of data processing networks, such as mesh networks, is increasing in terms of the number of network nodes and the number of networks links. This increase is driven, at least in part, to support large computational and memory requirements. A data processing network may use a system level cache (SLC) to reduce data access latency. The system level cache is distributed across a large set of home nodes in the network to share the cache capacity over all request nodes across multiple chips. The resulting networks, with large mesh dimensions, can exhibit large latencies for the read requests and associated snoop requests.

A hierarchy of cache nodes may be used, with the home nodes providing the last level in the hierarchy. The hierarchy may include local cache nodes, physically close to nodes that process data.

To reduce access latency incurred when accessing a subordinate node and associated memory, a home node may retrieve requested data by sending snoop requests to nodes that have copies of requested data in their local caches. This avoids the latency incurred when accessing a memory.

To reduce latency further, a “direct cache transfer” may be requested by sending a “forwarding snoop” message from the home node to the snoop target. In this case, the requested data is forwarded directly from the cache of the snoop target to the requesting node, bypassing the home node.

However, care must be taken to ensure that there is no data leakage, unauthorized viewing or other unauthorized usage of confidential information within a data processing network or system. In particular, there is a need to preserve confidentiality of confidential information and only allow sharing or viewing of it with an authorized requester in the data processing network.

### BRIEF DESCRIPTION OF THE DRAWINGS

The accompanying drawings provide visual representations which will be used to describe various representative embodiments more fully and can be used by those skilled in the art to better understand the representative embodiments disclosed and their inherent advantages. In these drawings, like reference numerals identify corresponding or analogous elements.

FIG. 1 is a simplified block diagram of a data processing network or system, in accordance with embodiments of the disclosure.

FIG. 2 is a sequence diagram of a normal snoop flow in a data processing network, in accordance with embodiments of the disclosure.

FIG. 3, a sequence diagram of a Direct Cache Transfer (DCT), in accordance with embodiments of the disclosure.

FIG. 4 is a data processing network, in accordance with embodiments of the disclosure.

FIG. 5 is a table that illustrates Physical Address Space (PAS) Fields, a table that illustrates PAS Fields, in accordance with embodiments of the disclosure.

FIG. 6 is a block diagram of a confidential computer architecture, in accordance with embodiments of the disclosure.

FIG. 7 is a flowchart, in accordance with embodiments of the disclosure.

FIG. 8 is a flow of a Read transaction with a correct MECID in a data processing network, in accordance with embodiments of the disclosure.

FIG. 9 is a flow of a Read transaction with an incorrect MECID in a data processing network, in accordance with embodiments of the disclosure.

FIG. 10 is a flow of a snoop flow back invalidation transaction in a data processing network, in accordance with embodiments of the disclosure.

FIG. 11 is a flow of a cache maintenance operation in a data processing network, in accordance with embodiments of the disclosure.

FIG. 12 is a snoop flow in a data processing network having a mismatched MECID, in accordance with embodiments of the disclosure.

FIG. 13 is a flowchart of a transaction flow downgrade, in accordance with embodiments of the disclosure.

FIG. 14 is a flowchart of a transaction flow downgrade, in accordance with embodiments of the disclosure.

FIG. 15 is a flowchart of a transaction flow downgrade, in accordance with embodiments of the disclosure.

### DETAILED DESCRIPTION

The various apparatus, devices and methods described herein provide mechanisms for intentionally and efficiently downgrading a performant forwarding flow of an incoming snoop to a non-forwarding snoop flow in a data processing network. Upon detection by a Snoopee agent or Snoopee in a data processing network of a memory encryption context identification (MECID) mismatch between an incoming snoop and a locally cached location of the Snoopee agent, the Snoopee agent responsively downgrades a forwarding snoop flow of the incoming snoop to a non-forwarding snoop flow and provides a mismatch indication of the MECID mismatch to a Home agent or node of the data processing network. This allows the Home agent to take the required action and permits reuse of generic requester agents of the data processing network for different markets and data network applications. As used herein, a forwarding snoop flow is one in which the Snoopee agent forwards requested data directly to a Requester. In a non-forwarding snoop flow, the Snoopee does not return requested data to the Requester and instead reports back to the Home node, as is described herein.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

Hardware coherency in a data processing network may be defined by an on-chip interconnect specification that defines the connection and management of functional blocks in system-on-chip (SoC) designs. Protocols define how functional blocks communicate with one another. As an example, Arm Limited's Advanced Microcontroller Bus Architecture (AMBA®) Coherent Hub Interface (CHI) protocol specification defines interfaces to connect fully coherent processors, for example, enables system components to share memory without needing software cache maintenance to maintain coherency. Regions of memory are considered to be coherent if writes to the same memory location by two or more components are observable by all components in the same order.

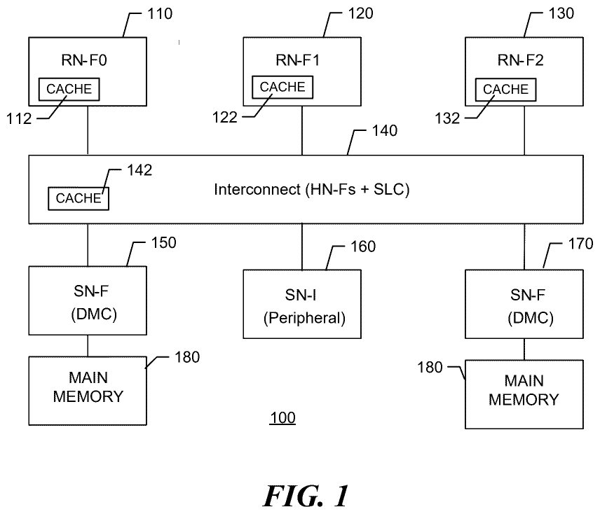

FIG. 1 is a simplified block diagram of an example coherent data processing network 100, in accordance with embodiments of the present disclosure. This coherent system includes three Requester agents or components 110, 120, 130, each with a local cache 112, 122, 132, respectively, and coherent protocol node. The coherent protocol ensures that no more than one copy of a data value is present when a store occurs at an address location. All Requester agents, also referred to herein as Requester nodes (RN), can see the correct data value at any given address location. After each store to a location, other Requester nodes are able to obtain a new copy of the data for their own local cache, thereby allowing multiple cached copies to exist. In certain embodiments, a cache line is defined as a 64-byte aligned memory region; coherency is maintained at cache line granularity. The cache protocol does not require main memory 180, such as dynamic random-access memory (DRAM), to be updated at all times.

The Request nodes (RNs) 110, 120, 130, also referred to as Requesting nodes, access and process data and may be, for example, a central processing unit (CPU) or CPU cluster. A Request node (RN) can be Fully Coherent, input/output (I/O) Coherent, or I/O Coherent with Distributed Virtual Memory (DVM) support. A Fully Coherent Request Node (RN-F) has one or more hardware-coherent caches and will accept and respond to snoop requests for accessing or changing the coherency state of cached data. A RN-F is permitted to generate all transactions defined by the protocol and support Snoop transactions. Transactions within the data processing network may involve an exchange of messages, such as requests and responses, including read, write and snoop requests. RN-F0 110, RN-F1 120 and RN-F2 130 in this example are Fully Coherent Request Nodes. A request node RN-F may be, for example, a central processing unit (CPU) core, a neural engine or other accelerator, or a Component Aggregation Layer that houses two or more CPU cores to be connected to one network port.

A data processing network may include a system level cache (SLC) to reduce the number of accesses to memory and reduce the latency of data accesses. The SLC may be distributed across a large set of Home nodes in a network to share the cache capacity over all network nodes across multiple chips. A Home agent, also referred to herein as a Home node (HN), provides a point of coherency for a subset of system address and provides a cache for storing data associated with the addresses. Coherency may be provided by a snoop filter (SF) that tracks data copied to caches in the network caches.

Subordinate nodes (SNs) 150, 170 provide access to data sources and sinks, such as memory 180 and peripheral devices SN-I 160. A memory or peripheral device may be located off-chip or on-chip. A SN receives a request from a HN, completes the requested action and returns a response. A SN-F subordinate node, such as 150, 170, is used for normal memory and can process non-snoopable Reads, Writes, Atomic requests and Cache Maintenance Operation (CMO) requests. SN-Fs 150, 170 may include a dynamic memory controller (DMC) as shown. SN-I subordinate note 160 may be used for peripherals or normal memory.

Interconnect 140 with its HNs and SLC, as well as optional cache 142, provides signal connections between the nodes and may have various topologies. For example, interconnect 140 may be configured to form a mesh network, a ring network, a crossbar network, or other network. The interconnect may provide a number of cross-points (XPs). Each cross-point provides one or more ports for coupling to request nodes and Home nodes. Cache 142 of Interconnect 140 is an optional cache.

A HN is a node located within Interconnect 140 that receives protocol transactions from Request Nodes 110, 120, 130. Interconnect 140 has Fully Coherent Home Nodes (HN-Fs) that can receive all types of requests from the RN-Fs 110, 120, 130 and has a Point of Coherence (PoC) that manages coherency by snooping the required RN-Fs, consolidates Snoop responses for a transaction and sends a single response to the requesting Request Node. HN-Fs further provide a Point of Serialization (PoS) that maintains ordering between memory requests.

While FIG. 1 shows the nodes of a single chip or network, it is understood that data processing networks can and do employ multiple chips that may be coupled by a chip-to-chip (C2C) link that enables communication of information between the two chips. Each chip may include request nodes (RNs), e.g., 110, 120, 130, Home nodes (HNs) and System Level Cache (SLC) of Interconnect 140, and subordinate nodes (SNs), SN-F 150, 170 and SN-I 160. While a small number of nodes is shown in FIG. 1, a network may contain any number of nodes, chips and necessary interconnects. For example, gateways such as chip-to-chip nodes (C2C nodes or CCNs) may couple between the network on one chip and a network on another chip. This enables formation of a network spanning multiple chips.

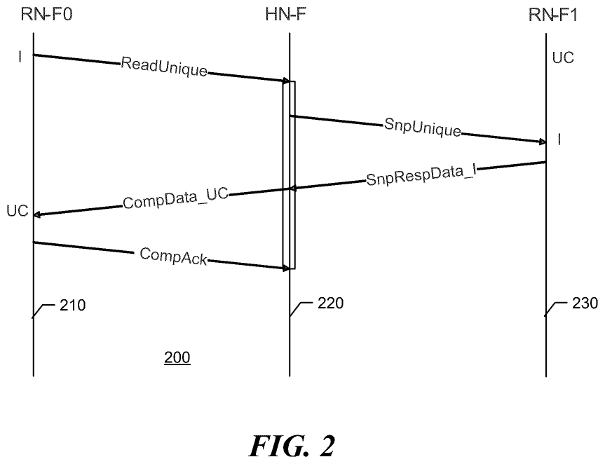

Referring now to FIG. 2, a sequence diagram of a normal non-forwarding snoop flow in a data processing network is illustrated. The diagram shows timeline 210 for a Requester request node (RN-F0), timeline 220 for a Home node (HN-F), and a timeline 230 for a request node (RN-F1); RN-F1 behaves as a Snoopee agent or Snoopee. Time flows in a downward vertical direction as indicated by the arrows. The transaction starts with RN-F0 issuing an initial request ReadUnique to Home HN-F. The Home HN-F sends a downstream forwarding snoop SnpUnique to Snoopee agent RN-F1. The Snoopee agent, or Snoopee RN-F1, returns a snoop response with data SnpRespData_I, to Home HN-F, which then returns a completion response with the returned data CompData_UC to Requester RN-F0. The transaction ends when Requester RN-F0 sends a completion acknowledgement CompAck to Home HN-F.

An interconnect specification, such as the AMBA® Coherent Hub Interface (CHI) by Arm Limited, includes a transaction flow optimization that permits a Snoopee to send data directly to a Requester as a result of a read request. This flow, known as Direct Cache Transfer (DCT), is a mechanism by which data is directly shared between the requestors without passing through the Home agent or node. The transfer is initiated by the Home node by sending a forwarding snoop request (FWD snoop) containing the node identifier of the forward requestor. DCT results in latency and power savings as the data message does not need to travel first to Home and then to the Requester.

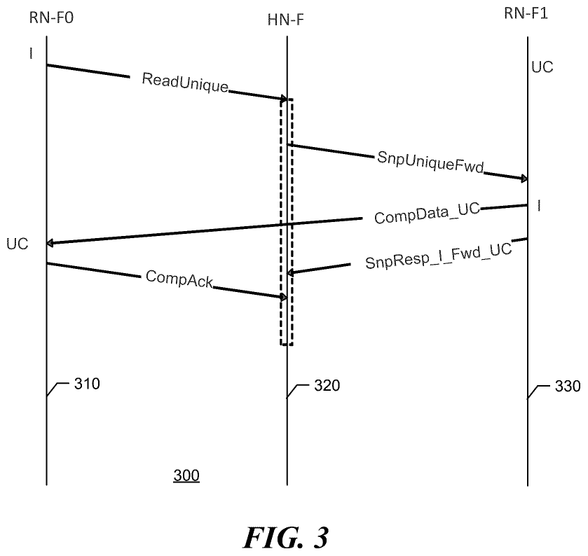

Referring to FIG. 3, a sequence diagram of a Direct Cache Transfer (DCT) is illustrated. The Snoopee RN-F1 sends data directly to the Requester RN-F0 in response to a read request made by Requester RN-F0 to HN-F.

The diagram shows timeline 310 for a Requester request node (RN-F0), timeline 320 for a Home node (HN-F), and a timeline 330 for a request node (RN-F1); RN-F1 behaves as a Snoopee agent or Snoopee. Time flows in a downward vertical direction as indicated by the arrows. The transaction starts with RN-F0 issuing an initial request ReadUnique to Home HN-F. The Home HN-F sends a downstream forwarding snoop SnpUniqueFwd to Snoopee agent RN-F1. The Snoopee agent, or Snoopee RN-F1, returns a combined completion response with the returned data CompData_UC directly to Requester RN-F0, while also sending a snoop response, SnpResp_I_Fwd_UC, to Home HN-F to let Home HN-F know that RN-F1 has provided the requested data directly the Requester RN-F0, as shown. Requester RN-F0 will send a completion acknowledgement CompAck to Home HN-F, ending the transaction. Because Snoopee RN-F1 can forward data directly to Requester RN-F0, the latency normally associated with the data going through Home HN-F is eliminated and overall latency reduced. This is illustrated in the dashed box on timeline 320. A comparison between the box on timeline 220 of FIG. 2 and timeline 320 of FIG. 3 illustrates that the transaction lifetime is shortened when the DCT of FIG. 3 is employed.

A Realm Management Extension (RME) is an extension to the Arm Limited Architecture. A further extension of RME is a feature called Memory Encryption Contexts (MEC). Arm Limited's AMBA® CHI specification provides support for both the RME foundations and the additional MEC extension. RME enables support for dynamic, attestable, and trusted execution environments, called Realms, to be run. The hardware-based isolation of RME allows execution contexts to run in different security states and to share network resources.

The MEC feature uses a MEC identification (MECID) as an index into a table of encryption contexts, either keys or tweaks, that contribute to the external memory encryption. When encrypted data is read from memory, the MECID is used by the encryption engine to decipher the contents and provide them to the original Requester. If the plaintext data is cached, it must be cached together with the associated MECID. This MECID then moves around the data processing network or system together with the plaintext data.

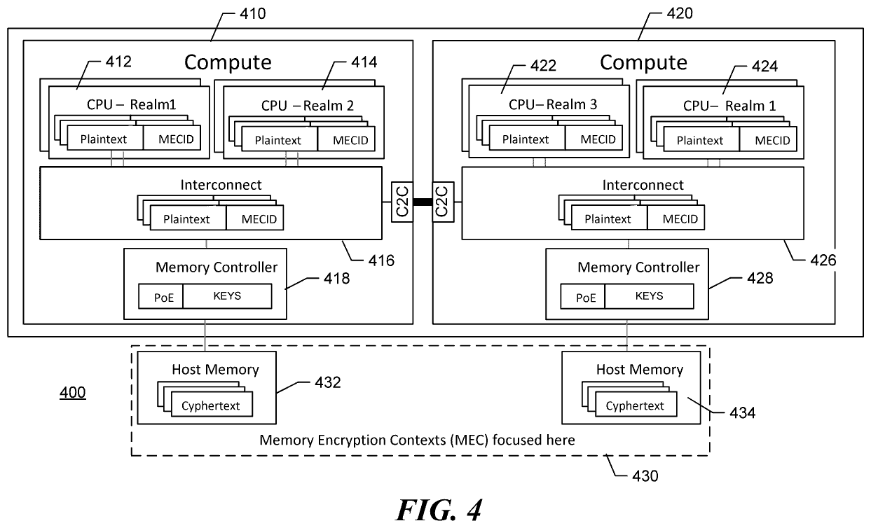

Referring to FIG. 4, the data processing network 400 shows an example environment in which two chips or networks 410 and 420 communicate via chip-to-chip (C2C) gateways, with each chip in communication with host memories 432 and 434, respectively. The individual chip or computing network each have their respective CPU Realms in communication with an Interconnect having a MECID and in communication with a memory controller having a Point of Encryption (PoE) and associated keys. Thus, computing chip 410 has Realm 1 412 and Realm 2 414 and associated MECIDs, and is in communication with Interconnect 416. Interconnect 416 communicates with Memory Controller 418 which is coupled to Host Memory 432 as shown. Similarly, computing chip 420 has Realm 3 422 and Realm 1 424 and associated MECIDs, and is in communication with Interconnect 426. Interconnect 426 communicates with Memory Controller 428 which is coupled to Host Memory 434 as shown.

FIG. 4 illustrates that the MEC feature uses a MEC identification (MECID) as an index into a table of encryption contexts, either keys or tweaks of the memory controller 418, 428, that contribute to the external memory encryption. When encrypted data is read from memory 432, 434, the MECID is used by the encryption engine to decipher the contents and provide them to the original Requester. If the plaintext data is cached at 412, 414, 422, 424, 416 or 426, for instance, it must be cached together with the associated MECID. This MECID then moves around the data processing network or system together with the plaintext data. From the above, it can be seen that MECID is used by a memory encryption engine as an index into a table of encryption contexts, either keys or tweaks, that contribute to the external memory encryption.

The original MEC feature is only applicable to the Realm Physical Address Space (PAS) and acts as a second line of defense around confidential information leakage. MECIDs are associated to a Realm VM by the trusted Realm Memory Manager (RMM) software. If multiple mappings occur to the same physical page with different MECIDs, then the RMM has gone wrong. Without MECID checks in the caches, plaintext data can leak between Realms, as an example. MECID checks can provide a second line of defense in depth and prevent these plaintext data leaks. A broken RMM can compromise Realm data in other ways.

The first line of defense in the Realm space is the RMM, described below in connection with FIG. 6, that ensures that malicious agents are not given access to physical locations that they are not permitted to observe. There is thus not an explicit requirement for caches and other system components to cross check the cached MECID with any incoming MECID from another request or snoop. This means that it is always permissible to carry out a DCT snoop transaction flow when requested, even when the cached MECID is not the same as the incoming snoop MECID.

A further extension to the RME feature, known as Granular Data Isolation (GDI), is designed to enable memory isolation of non-Processing Element data flows from Processing Elements (PEs) within an RME system. To achieve this, two new Physical Address Spaces (PAS's) are defined for System Agent and Non-secure Protected use cases. The Non-secure Protected use case is intended for media pipelines, with flexible, non-secure software management and strong data confidentiality. Memory is managed by a PE, using the Memory Management Unit (MMU), also referred to as a System Memory Management Unit (SMMU), on behalf of a non-secure device in protected mode. The System Agent use case is intended for use by higher security, on-chip sub-systems that require memory allocation on request such as, for example, biometric data processing. The System Agent PAS is isolated from PEs and any additional memory management is independent from the PEs. Processing Elements (PEs) are not permitted to directly access either of these two PAS, except for performing cache maintenance in a Cache Maintenance Operation (CMO) through to the Point of Physical Aliasing (PoPA), a point where updates to a location in one PAS are visible to other PAS's. Non-PE Requesters can access the System Agent and Non-secure Protected PAS's.

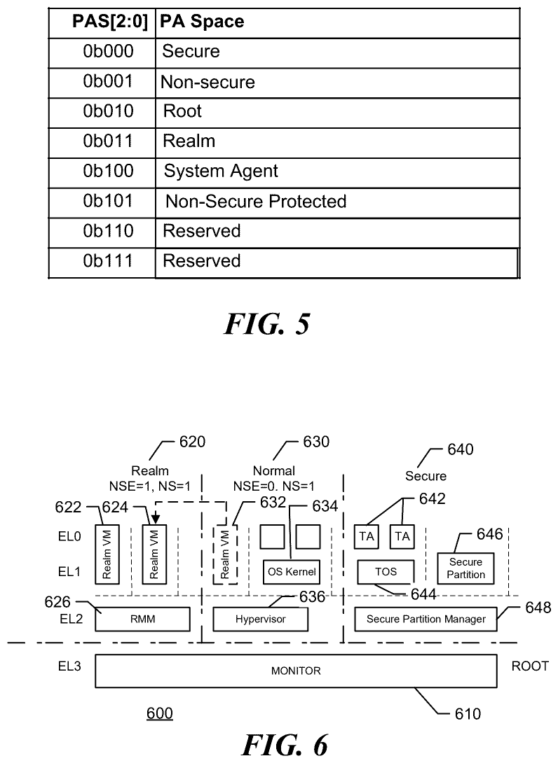

Referring now to FIG. 5, a table that illustrates PAS field encodings, including for Non-secure Protected PAS and System Agent PAS, is shown. As an example, the PAS field for Non-secure Protected PAS is 0b101 and for System Agent PAS is 0b100. The PAS field is included on the Request and Snoop channels.

GDI adds these two PAS, Non-secure Protected and System Agent. The MEC feature may be used in conjunction with these new System Agent PAS and Non-Secure Protected PAS as a first line of defense to cryptographically isolate media or biometric paths from each other. The MECID values for NSP will be set up by a security processor and associated with the device StreamIDs that make up the media path. This means that a cache receiving a request where the cached MECID does not match the incoming MECID indicates that some intentional action is needed. It is noted that the MECID values used by a Requester for the SA space are internally defined. Any memory management is independent from the PEs.

This intentional action will depend on the type of request being received. The MECID just needs to prevent disclosure of confidential information. There is not a concern about the impact on data integrity, and some loss of coherency is acceptable. For a read or write transaction, the intentional action may be the overwriting with a known/random value of cached data; for example, setting it to all 1's. Further, for a partial write, partial data could then be merged and the MECID updated with the MECID of the write. For a full write, the line is fully overwritten and the MECID updated with the MECID of the write. For a snoop transaction, specifically a forwarding snoop, the Snoopee will not necessarily know what caused the snoop. The overwriting of data is one potential solution prior to the use of the DCT transaction flow. The MECID checks and overwriting of data are part of the solution where the CPUs are not trusted.

While the overwriting of data ensures that confidential data is not compromised, it may not be the best solution in all cases. As disclosed herein, the architecture of a data processing network provides for the explicit downgrading of forwarding snoop (DCT) flow to a non-forwarding snoop flow, where the requested data is provided to the Home agent or node by the Snoopee RN-F, along with the originally cached MECID and an indication that there was a MECID mismatch. This then allows Home HN-F to take the appropriate action, and does not require different behavior by the Requester depending on the PAS being accessed.

As the Snoopee RN-1 would always have to detect whether or not the MECID matched, by providing an indication of the mismatch to Home HN-F together with any non-forwarded data, the Home HN-F is not required to also perform a second MECID comparison, saving logic, power and latency within the data processing network.

Further, the Home agent for a Realm space may permit the plaintext data to be provided to the other Requester that used a mismatched MECID. For the Non-secure Protected PAS or the System Agent PAS, the Home HN-F would either have to perform the overwriting of data with known or random values, or perform a writeback of the cached data to memory using the cached MECID, chased by a request with the alternative MECID.

The architected downgrade defined herein allows for a simple and consistent detection by any Snoopee, and permits the Home agent or node to then be designed in a way that reflects the necessary security requirements. On a MECID mismatch, the forwarding snoop is downgraded to an invalidating snoop. This defined downgrade allows for deterministic behavior around coherency, as the Home agent or node can then ensure that any other cached copies are invalidated if required. This can then ensure that shared copies of the same cache line all contain a consistent value.

A new GDI property, GDI_non_PE_RNF, determines the behavior of an RN-F based on whether it contains a Processing Element (PE) and accordingly has the ability to constrain the behavior of an RN-F. Where the GDI_non_PE_RNF value is true, an RN-F is permitted to issue any transaction with PAS set to System Agent or Non-secure Protected and is further permitted to allocate or cache lines to System Agent or Non-secure Protected PAS locations. When GDI_non_PE_RNF is false, all transactions, with the exception of a Clean and Invalidate to the Point Of Physical Aliasing (PoPA) cache maintenance operation., are not permitted to set PAS to Agent or Non-secure Protected. The RN-F has to respond with SnpResp_I to any incoming snoop with PAS set to Agent or Non-secure Protected. Further, the RN-F cannot pull data in response to a stashing snoop where the PAS is set to System Agent or Non-secure Protected.

When considering the presence of a MECID mismatch with regard to a Realm MECID versus MECIDs associated with Agent or Non-secure Protected PAS's, consider the example Confidential Computer Architecture (CCA) 600 of FIG. 6 and its isolation architecture RME. RME allows hypervisors 636 to create and manage special execution environments for workloads called Realms. A Realm PAS 620 is a protected environment that is designed to provide additional security to workloads such as virtual machines (VMs) 622, 624, 632. When a virtual machine runs within a Realm, a hypervisor 636 has the same powers to create, destroy, schedule, add, or remove resources such memory and devices as they do for traditional virtual machines. A key difference is that a hypervisor 636 cannot access the code or memory of a Realm. In this sense the hypervisor is deprivileged, and a workload can use attestation to verify that this deprivileging has occurred before it loads any sensitive code or data. RME provides another tool that can help security architects reduce the amount of code that can access workloads and can be used to further harden a platform that supports virtualization. RME also standardizes support for memory encryption and attestation. The CCA 600 allows deployment of applications or Virtual Machines (VMs) while preventing access by more privileged software entities such as a hypervisor. However, it is these privileged software entities that typically manage resources like memory. In this case a privileged software entity, for example a hypervisor, does have access to the memory of an application or VM.

The CCA allows the hypervisor to control the VM, but removes the right for access to the code, register state, or data that is used by that VM. The separation is enabled by creating Realms, protected VM execution spaces. A Realm has complete isolation from the Normal (Root) world PAS 630 in terms of code execution and data access. The CCA achieves this separation through a combination of architectural hardware extensions and firmware.

Within the CCA, the hardware extensions on an Application PE are called the Realm Management Extension (RME). The RME interacts with specialist firmware, called Realm Management Monitor (RMM) 626 in Exception level 2, for Realm control, and the Monitor code 610 in Exception level 3.

Realm PAS 620 is a CCA environment that can be dynamically allocated by the Normal world PAS Host. The Host is the supervisory software that manages an application or Virtual Machine (VM). The initial state of a Realm PAS 620, and of the platform on which it executes, can be attested. Attestation allows the Realm owner to establish trust in the Realm, before provisioning any secrets to it. The Realm does not have to inherit the trust from the Non-secure hypervisor which controls it.

The Host can allocate and manage resource allocation. The Host can manage the scheduling of the Realm VM operation. However, the Host cannot observe or modify the instructions executed by the Realm.

Realms can be created and destroyed under Host control. Pages can be added or removed through Host requests in a way that is similar to a hypervisor managing any other non-confidential VM. CCA 600 allows Realms to be created and destroyed on demand under the control of the Normal world PAS 630 host. Resources can be added or retrieved from Realms dynamically.

To run a CCA system, a Host needs to be modified. The Host continues to control the non-confidential VMs but needs to communicate with the CCA firmware, in particular the Realm Management Monitor (RMM) 626.

A Realm Virtual Machine 622, 624 is different to a Trusted OS (TOS) 644 or Trusted application (TA) 642 because the Realm VM is controlled from the Normal world PAS Host. In areas like creation and memory allocation, the Realm VM acts like any other VM being controlled from the Host.

A difference between the Realm VM execution and the Trusted Operating System (TOS) execution is that the Realm PAS 620 does not have any physical interrupts enabled. All interrupts for the Realm are virtualized by the hypervisor 636 and then signaled to the Realm through commands passed to the RMM 626. This means that a compromised hypervisor 636 might prevent execution of the Realm VM, so there is no guarantee of Realm execution.

The Realm execution and memory access are initialized by the controlling Host software, for example the hypervisor 636. The Realm PAS 620 does not have to be verified by the Host. The Realm PAS has an independent Chain of Trust from those used by the Normal world PAS 630 host and Secure world PAS 640. The Realm PAS 620 is also completely isolated from the controlling software. If a Realm PAS 620 is initialized by a Host, the Host has no ability to see the data or data memory of the Realm.

The main difference between the use of Realm PAS 620 and TOS in Secure world PAS 640 is in the design intent between Secure execution and Realm execution. Trusted applications may be used for platform-specific services owned by actors close to the system development, such as Silicone Providers (SiPs) and Original Equipment Manufacturers (OEMs). Realm execution allows general developers to execute code on a system without being involved in complex business relationships with the developers of the compute system.

Referring back to the discussion of MEC and MECIDs, MEC are configurations of encryption that are associated with areas of memory, as assigned by the MMU. The RME system architecture, has Realm, Secure and Normal (Root) PAS's, prior to GDI which introduces the additional System Agent or Non-secure Protected PAS's discussed above. as illustrated in FIG. 6. The RME system architecture states that the Realm, Secure, and Root PAS's are encrypted. The encryption key or tweak, or encryption context, used with each of these PAS's is global within that PAS. So, for example, for the Realm PAS, all Realm memory uses the same encryption context. With MEC this concept is broadened, and for the Realm PAS specifically, each Realm may have a unique encryption context. This provides additional protection to the isolation already provided in RME. Realms and RMM itself can all have separate encryption. The MECIDs are identifying tags that are associated with different Memory Encryption Contexts. MECIDs are assigned to different software entities in the system, for example, Realms or the RMM.

MECIDs are not themselves system-global identifiers and so to be system-global identifiers they must be associated with a physical address (PA) space. The MECID is assigned by software (the RMM for a Realm PAS), using a combination of system register values and page table bits, for example. MEC allows bodies of software, Realms, and the RMM to use more than one MECID register, with page table bits used to select which of the MECID registers applies to a specific memory region mapped to that body of software. This, for example, enables the RMM to use one MECID register to manage its own data structures and another to manage those of the Realm it is currently managing, such as the Realm's stage page tables. For a Realm, having access to more than one MECID register means that it can share encrypted Realm PAS memory with other Realms. This means that memory spaces can be allocated a Memory Encryption Context that can be shared between multiple Realms to allow these Realms to have shared encrypted memory. In addition, every transaction, such as every Advanced Microcontroller Bus Architecture (AMBA) transaction, coming from any entity with a MECID is annotated with that entity's MECID attribute.

When a transaction is performed involving an area of memory associated with a MECID, the MECID is used to retrieve a tweak or encryption key (an encryption context) to be used for encryption or decryption of the transaction. The encryption key is data that modifies the encryption operation. At system boot, a set of encryption contexts may be generated and stored by the Memory Protection Engine (MPE). These contexts are indexed by the MECID and can be updated from a request from the root world when a MECID is being reused by a different entity in the system.

As an example, the MECID size may be between 1 and 16 bits and is architecturally discoverable. The size of the MECID means that they are too small to be used as a tweak. Because the size of the MECID is limited, this means that during the lifetime of the running system MECIDs will be reused between different entities in the system. Therefore, every assignment of a MECID must happen only after the MECID's associated encryption context is invalidated and then it can be regenerated.

MEC Encryption Keys may only be stored in write-once registers, only accessible by Root requests. Once a key is reset, the value must be set to a default value different from all other active MEC Encryption Keys.

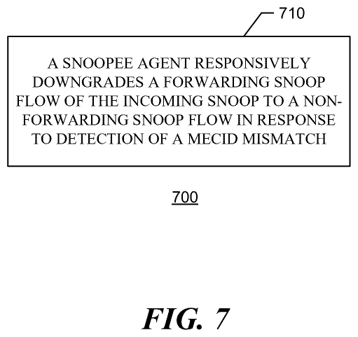

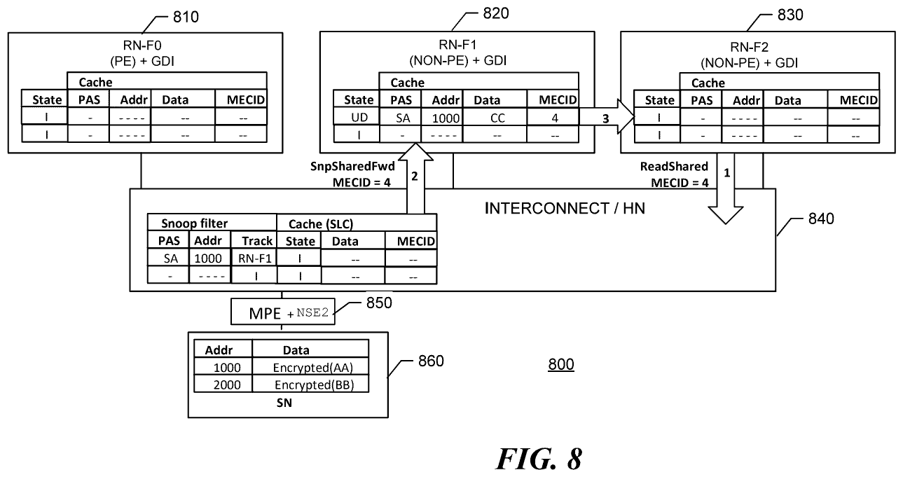

The explicit downgrading of the forwarding snoop (DCT) flow to a non-forwarding snoop flow is controlled by the Snoopee agent/node, the Snoopee, the agent in the best position to know where there is a MECID mismatch. The operation by the Snoopee is shown in flowchart 700 of FIG. 7. At 710, a Snoopee agent RN-F of a data processing network that is configured to respond to detection of a memory encryption context identification (MECID) mismatch between an incoming snoop and a locally cached location of the Snoopee agent by responsively downgrading a forwarding snoop flow of the incoming snoop to a non-forwarding snoop flow. Further, the requested data is provided to the Home agent HN-F by the Snoopee RN-F, along with the originally cached MECID and an indication that there was a MECID mismatch. This allows Home HN-F to take the appropriate action, and does not require different behavior by the Requester depending on the PAS being accessed. The key role played by the Snoopee RN-F is illustrated in FIGS. 8-11.

Upon a MECID mismatch detected in a snoop flow operation of a non-PE GDI RN-F, there are several options. Firstly, the RN-F could not permit any DCT operation, regardless of MECID. DCT operation is not permitted, thereby foregoing potential performance enhancement There is no requirement upon detection of a MECID mismatch of a solution at the Request node RN. Home node HN of the interconnect is relied upon to resolve the MECID mismatch. Data is always provided by the RN-F back to the Home node HN to resolve. Secondly, the RN-F may detect the MECID only. Upon detection of the MECID mismatch, it will downgrade the forwarding snoop to a non-forwarding snoop and provide plaintext plus its cached MECID back to the Home node. The Snoopee RN-F needs the MECID of the forwarding snoop request. For a Realm PAS, the MECID mismatch may be ignored. A PAS of Non-secure Protected or System Agent can be used to alter behavior at the interconnect for MECID mismatch resolution. In the case of Non-secure Protected or System Agent PAS, overwriting of data requirements may be performed. This approach provides a performant approach in normal cases where the MECID does match. Thirdly, there is the option of detecting MECID mismatch and subsequent data overwriting. On a MECID mismatch for a forwarding snoop, the Snoopee RN-F detects the MECID mismatch and drives overwritten data on a CompData response. The MECID must be sent to the Snoopee on the forwarding snoop transaction so that the Snoopee can make the determination. However, the RN-F is not aware of the wider system structure, and so might not know the corrective actions to take in order to ensure system consistency with regard to that location. Hence, this third option may be less optimal.

In addition to the overwriting of data, for systems in which incorrect MECID values may be tolerated another option may be cleaning a stored line of data back to memory, such as a dynamic random-access memory (DRAM) with the Snoopee's stored MECID and then reloading from DRMA with the new MECID.

Detection of a MECID mismatch by a Snoopee may be communicated to the Home node HN via a mismatched MECID field in a DAT channel. For example, a Mismatched MECID field can inform the Home node that the Snoopee has detected a MECID mismatch between the incoming snoop flow MECID field value and the MECID value in the local cache of the Snoopee for that location. Such a field can be used as an indicated to the Home node that there is a MECID mismatch that the home might need to resolve. Again, this approach optimizes Home node design and operation because the Home node does not have to perform the same detection that the Snoopee RN-F is already performing.

Referring to FIG. 8, a flow of a Read transaction of a data processing network in which the MECID is correct and there is not a MEC mismatch shown. Requester agents or nodes RN-F0 810, RN-F1 820 (Snoopee or Snoopee agent) and RN-F2 830 (Requester or requester agent) are in communication with Interconnect 840; interconnect 840 is coupled to memory controller 850 having a MPE and memory 860. At arrows 1, 2, 3 it can be seen that the MECID value of 4 is correct and shared; there is not a MECID mismatch. The ReadShared between Requester RN-F2 830 to Interconnect 840 with Home node has a MECID value of 4 at Arrow 1; the SnpSharedFwd from Interconnect 840 to RN-F1 820 has a MECID value of 4 at Arrow 2. Because there is the correct MECID and no mismatch, Snoopee RN-F1 820 can forward data directly to Requester RN-F2, as indicated by Arrow 3.

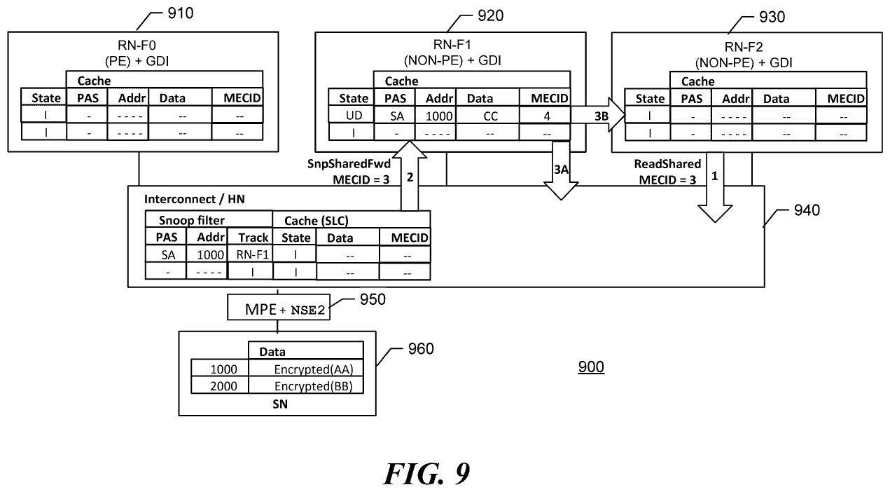

The next scenario of FIG. 9 is different in that there is a MECID mismatch in the Read transaction. Requester agents or nodes RN-F0 910, RN-F1 920 and RN-F2 930 are in communication with Interconnect 940 in data processing network 900; interconnect 940 is coupled to memory controller 950 having a MPE and memory 960. The ReadShared between Requester RN-F2 930 to Interconnect/Home node 940 has a MECID of 3 at Arrow 1; the SnpSharedFwd from Interconnect/Home node 940 to Snoopee RN-F1 920 also has a MECID of 3 at Arrow 2. The stored MECID value of Snoopee RN-F1 920 is, however, different with a MECID value of 4. Because of this MECID mismatch, there are two options, indicated by arrows 3A and 3B. For the first option, indicated by arrow 3A, the Snoopee RN-F1 noticed the MECID mismatch so downgrades the forwarding snoop to a non-forwarding snoop and sends Data=O×CC and MECID=4 back to interconnect Home Node, which is given responsibility to resolve the mismatch. The Home node at interconnect 940 may, for example, overwrite data or may also provide overwritten data to Requester RN-F2 in a non-DCT flow. In option 3B, Snoopee RN-F1 920 overwrites the data and forwards it to Requester RN-F2 in a DCT flow.

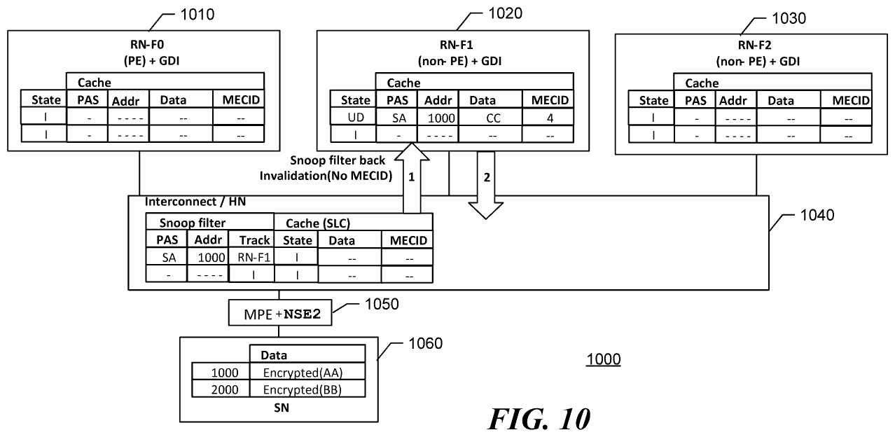

Referring to data processing network 1000 of FIG. 10, there is illustrated snoop flow back invalidation. Requester agents or nodes RN-F0 1010, RN-F1 1020 and RN-F2 1030 are in communication with Interconnect 1040 in data processing network 1000; interconnect 1040 is coupled to memory controller 1050 having a MPE and memory 1060. A snoop filter back invalidation with no MECID is initialized by the Home node of interconnect 1040 to RN-F1 1020 at Arrow 1. For the response at Arrow 2, the Home node is expecting a MECID mismatch as it was not actively tracking the MECID for that location in the snoop filter. No corrective action is required and the Home node can issue a write back of the data provided in SnpRespData along with the provided MECID back to memory.

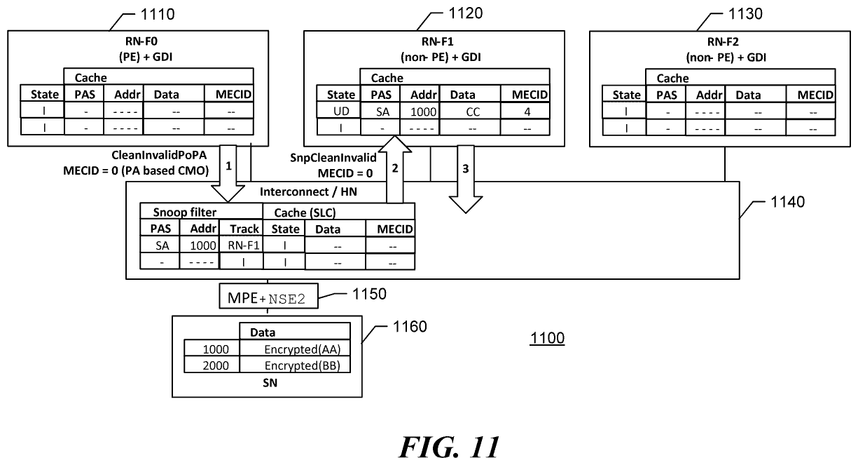

Consider next a Cache Maintenance Operation (CMO). In FIG. 11, Requester agents or nodes RN-F0 1110, RN-F1 1120 and RN-F2 1130 are in communication with Interconnect 1140 in data processing network 1100; interconnect 1140 is coupled to memory controller 1150 having a MPE and memory 1160. RN-F0 1110 sends to Home node of interconnect 1140 a CleanInvalidPoPA transaction at Arrow 1 that is observable to a later transaction from any agent to the same memory location in any PAS. This transaction has a MECID of 0. The Home node of interconnect 1140 sends a Snoop SnpCleanInvalid with a MECID of 0 to RN-F1 1120 at Arrow 2. It can be seen that RN-F1 1120 has a MECID of 4, however. In response to this mismatch, the RN-F can provide the cached data back to the Home along with its cached MECID. The Home is expecting a MECID mismatch as CMO requests from Requesters do not include an accurate MECID. No corrective action is required and the Home node can issue a write back of the data provided in SnpRespData along with the provided MECID back to memory.

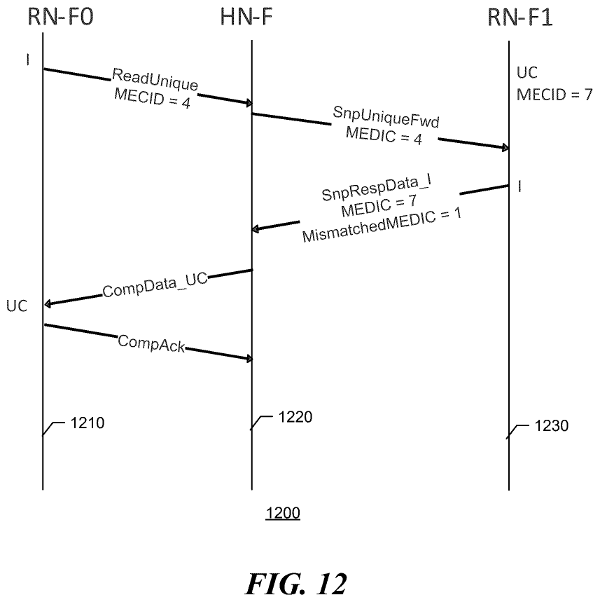

Referring now to sequence diagram 1200 of FIG. 12, a snoop flow in a data processing network having a mismatched MECID is illustrated. The diagram shows timeline 1210 for a Requester request node (RN-F0), timeline 1220 for a Home node (HN-F), and a timeline 1230 for a request node (RN-F1); RN-F1 behaves as a Snoopee agent or Snoopee. Time flows in a downward vertical direction as indicated by the arrows.

The transaction starts with RN-F0 issuing an initial request ReadUnique to Home HN-F. The Home HN-F sends a forwarding snoop SnpUniqueFwd with a MECID value of 4 to Snoopee agent RN-F1. The Snoopee agent, or Snoopee RN-F1, detects the MECID mismatch between the MECID value of 4 provided by the HN-F and its located stored MECID value of 7. Upon this detection RN-F1 downgrades the forwarding snoop to a non-forwarding snoop and provides its cache MECID value to 7 back to HN-F, together with the cached data for that location. The return SnpRespData_I message additionally has a MismatchedMECID field in the DAT channel=1, indicating to the Home node HN-F that the Snoopee RN-F1 has detected a mismatch between the incoming snoop MECID field value and the MECID value in the local cache of RN-F1 for that particular data location. Home node HN-F potentially takes a corrective action. As previously discussed, this action could include overwriting the data received from RN-F1, writing the dirty line back to memory with MECID=7 and reload with MECID=4, or drop the clean line and reload from memory with MECID=4. Home HN-F after taking some or no action, then returns a completion response with the returned data CompData_UC to Requester RN-F0 as shown. The transaction ends when Requester RN-F0 sends a completion acknowledgement CompAck to Home HN-F.

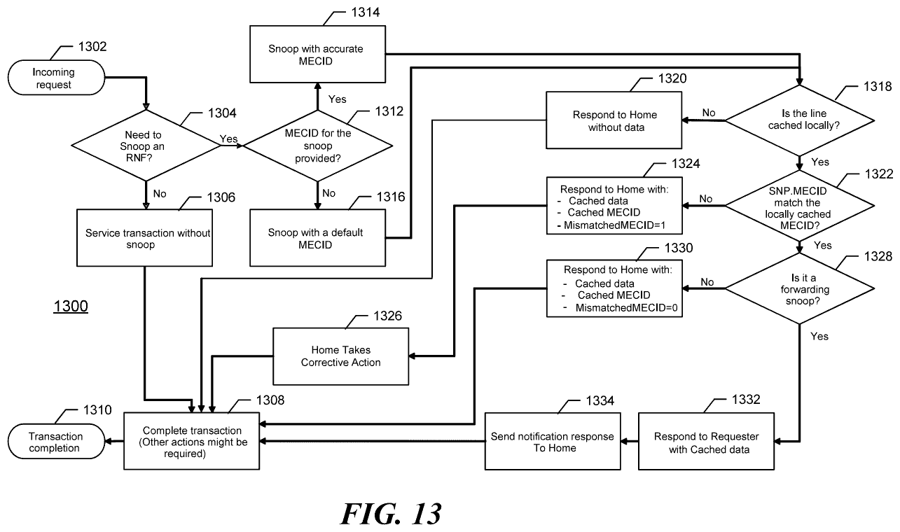

Flowchart 1300 of FIG. 13 illustrates an overview of methodology and actions taken in a data processing network in response to the detection of a MECID mismatch in a forward snoop flow. At 1302 there is an incoming request. The query at decision block 1304 is whether a RN-F needs to be snooped. If no, then the transaction is serviced without snoop at 1306. The transaction is completed at blocks 1308, 1310, with any additional action performed at block 1308. If the transaction is a snoop of a Snoopee RN-F, then the flow continues from block 1304 to decision block 1312, in which the query is whether a MECID has been provided for the snoop. If no, then at block 1316 the forward snoop is performed with a default MECID and the flow continues to block 1318. If the MECID for the snoop is provided, then the flow goes from block 1312 to block 1314 in which a snoop may be performed with an accurate MECID. At decision block 1318, the query is whether the line has been cached locally at the Snoopee. If no, then the Snoopee RN-F responds to the Home node HN-F without data at 1320 and the transaction is completed at blocks 1308, 1310. If the line has been cached locally at the Snoopee, the query at decision block 1322 is whether the snoop MECID provided to the Snoopee matches the locally cached MECID of the Snoopee RN-F. If no, there is a mismatch and flow continues to block 1324. The Snoopee RN-F responds to the Home node HN-F with cached data, its locally cached MECID and an indication of the MECID mismatch, such as MismatchedMECID=1. At block 1326, the Home node HN-F may take correction action, as discuss at length above.

Returning to decision block 1322, if there is not a mismatch between the snoop MECID and the locally cached MECID of the Snoopee RN-F, the flow continues to decision block 1328 with the query of whether the snoop is a forwarding snoop. If not, then the Snoopee RN-F responds to the Home node HN-F with cached data, its locally cached MECID and an indication of the MECID mismatch, such as MismatchedMECID=0. The transaction is completed at blocks 1308, 1310. If there is no MECID mismatch and the transaction is a forwarding snoop, then the flow continues from decision block 1328 to block 1332. The Snoopee RN-F responds to the Requester who requested the data via snoop with its cached data. Next at block 1334, the Snoopee RN-F sends a notification response such as Comp_Data_UC to the Home node. The transaction is completed at blocks 1308, 1310.

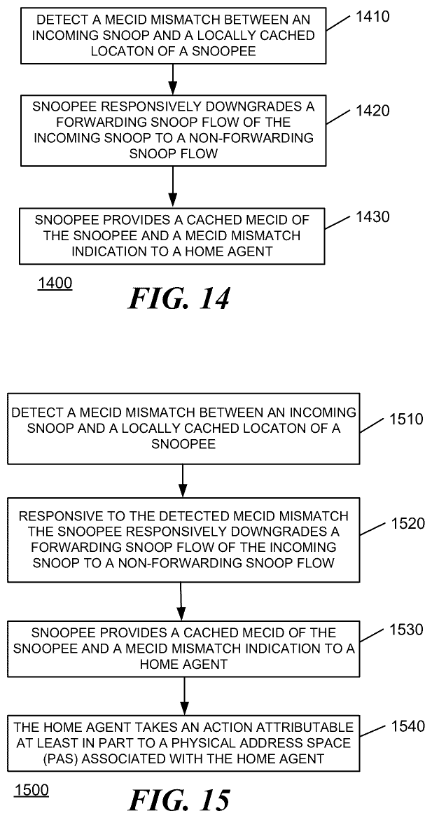

As indicated above and shown in flow 700 of FIG. 7, downgrading of a forwarding snoop flow to a non-forwarding snoop flow upon detection of a MECID mismatch by a Snoopee agent, i.e. Snoopee RN-F, is controlled by the Snoopee agent. FIGS. 14 and 15 further illustrate this process and how the Snoopee agent operates within a data processing network. In flow 1400 of FIG. 14, the Snoopee agent detects a MECID mismatch between an incoming snoop and a locally cached MECID at a location of the Snoopee agent at block 1410. At 1420, the Snoopee responsively downgrades a forwarding snoop flow of the incoming snoop to a non-forwarding snoop flow, in which the Snoopee agent does not forward requested data directly to a requester in the data processing network. Finally, at block 1430, the Snoopee agent provides a cached MECID of the Snoopee and a MECID mismatch indication to a home agent.

In flow 1500 of FIG. 15, the Snoopee detects a MECID mismatch between an incoming snoop and a locally cached MECID at a location of the Snoopee agent at block 1510. At 1520, the Snoopee responsively downgrades a forwarding snoop flow of the incoming snoop to a non-forwarding snoop flow, in which the Snoopee agent does not forward requested data directly to a requester in the data processing network. At block 1530, the Snoopee agent provides a cached MECID of the Snoopee and a MECID mismatch indication to a home agent. At block 1540, the home agent takes an action attributable at least in part to a PAS associated with the home agent. As discussed above, the PAS may be a Realm PAS, a System Agent PAS or a Non-secure Protected PAS that may experience a MECID mismatch.

The embodiments described herein are combinable.

In one embodiment, a method includes detecting in a data processing network of a memory encryption context identification (MECID) mismatch between a MECID of an incoming snoop of a forwarding snoop flow from a home agent of the data processing network and a locally cached MECID of a snoopee agent of the data processing network and responsive to the MECID mismatch detection, the snoopee agent downgrading the forwarding snoop flow to a non-forwarding snoop flow and providing a mismatch indication of the MECID mismatch to the home agent.

In another embodiment, the forwarding snoop flow is a flow of a direct cache transfer (DCT).

In another embodiment, the method further including the snoopee agent directly providing requested data to a requester agent when there is not a MECID mismatch.

In another embodiment, the snoopee agent responsively downgrading the forwarding snoop flow to the non-forwarding snoop flow includes the snoopee agent providing to the home agent data requested by a requester agent of the data processing network, together with a cached MECID of the snoopee agent and the mismatch indication of the MECID mismatch between a value of the cached MECID and a value of an incoming MECID from the requester agent.

In another embodiment, the method further including the home agent taking action responsive to receiving the mismatch indication, said action attributable at least in part to a physical address space (PAS) associated with the home agent.

In another embodiment, where the home agent is a home agent of a non-secure protected PAS or a system agent PAS that has received the mismatch indication provided by the snoopee agent when the incoming MECID from the requester agent is mismatched from the cached MECID and the action by the home agent includes one or more of:
overwriting the cached data;
performing a write back of the requested data cached by the snoopee agent to a memory using the cached MECID and reading from memory with a new MECID;
dropping a clean line from the snoopee agent and reloading the dropped line from a memory with a new MECID; and
invalidating data of other requester agents of the network that correspond to the cached data of the snoopee agent.

In another embodiment, where the home agent is a home agent of a realm physical address space (PAS) that is a protected VM execution environment, the home agent optionally providing plaintext data to the requester agent when the incoming MECID from the requester agent is mismatched from the cached MECID, as indicated by the mismatch indication provided by the snoopee agent to the home agent.

In another embodiment, the method further including the home agent invalidating cached copies of requested data responsive to receiving the mismatch indication of the mismatch between the value of the cached MECID and the value of the incoming MECID from the requester agent.

In another embodiment, where the snoopee agent responsively downgrading the forwarding snoop flow to the non-forwarding snoop flow includes the snoopee agent providing the requested data to the home agent and further not providing the requested data to the requester agent.

In another embodiment, the method further including the requester agent not changing how data is requested independent of a physical address space (PAS) that is accessed for data.

In another embodiment, where the PAS is one or more of a realm PAS, a system agent PAS and a non-secure protected PAS.

In another embodiment, the method further including the snoopee agent detecting when there is a mismatch between a value of a cached MECID of the snoopee agent and a value of an incoming MECID from a requester agent.

In another embodiment, where the mismatch indication of the mismatch between the cached MECID and the incoming MECID is detected by the snoopee agent performing a comparison of the cached MECID and the incoming MECID.

In one embodiment, an apparatus including a snoopee agent of a data processing network that is configured to respond to detection of a memory encryption context identification (MECID) mismatch between a MECID of an incoming snoop and a locally cached MECID of the snoopee agent by responsively downgrading a forwarding snoop flow of the incoming snoop to a non-forwarding snoop flow.

In another embodiment, where the snoopee agent is further configured such that, responsive to detection of the memory encryption context identification (MECID) mismatch between the incoming snoop and the locally cached MECID, the snoopee agent additionally provides a mismatch indication of the MECID mismatch to a home agent of the data processing network.

In another embodiment, the snoopee agent is further configured such that when there is not a MECID mismatch, the snoopee agent directly provides requested data to a requester agent of the data processing network.

In another embodiment, where the snoopee agent is configured to responsively downgrade the forwarding snoop flow to the non-forwarding snoop flow with the snoopee agent configured to provide the requested data to the home agent and further to not provide the requested data to a requester agent.

In another embodiment, where the snoopee agent is configured to responsively downgrade the forwarding snoop flow to the non-forwarding snoop flow with the snoopee agent configured to provide to a home agent of the data processing network data requested by a requester agent of the data processing network, together with a cached MECID of the snoopee agent and the mismatch indication of the MECID mismatch between a value of the cached MECID and a value of an incoming MECID from the requester agent.

In another embodiment, where the home agent is further configured to take action responsive to receiving the mismatch indication, said action attributable at least in part to a physical address space (PAS) associated with the home agent.

In another embodiment, where the home agent is a home agent of a realm physical address space (PAS) that is a protected VM execution environment and the home agent optionally provides plaintext data to the requester agent when the incoming MECID from the requester agent is mismatched from the cached MECID, as indicated by the mismatch indication provided by the snoopee agent to the home agent.

In another embodiment, where the home agent is a home agent of a non-secure protected PAS or a system agent PAS that has received the mismatch indication provided by the snoopee agent when the incoming MECID from the requester agent is mismatched from the cached MECID, the action by the home agent includes one or more of:
overwriting the cached data;
performing a write back of the requested data cached by the snoopee agent to a memory using the cached MECID and reading back from memory using a new MECID;
dropping a clean line from the snoopee agent and reloading the dropped line from a memory with a new MECID; and
invalidating data of other requester agents of the network that correspond to the cached data of the snoopee agent.

In another embodiment, where the home agent is further configured to invalidate cached copies of requested data responsive to receiving the mismatch indication of the mismatch between the value of the cached MECID and the value of the incoming MECID from the requester agent.

In another embodiment, where the snoopee agent is further configured to detect when there is a mismatch between a value of a cached MECID of the snoopee agent and a value of an incoming MECID from a requester agent.

In another embodiment, where the snoopee agent is further configured to detect the mismatch indication of the mismatch between the cached MECID and the incoming MECID by performing a comparison of the cached MECID and the incoming MECID.

In another embodiment, including a non-transitory computer-readable medium storing computer-readable code for fabrication of the apparatus described above.

In one embodiment, a method includes detecting in a data processing network of a memory encryption context identification (MECID) mismatch between a MECID of an incoming snoop of a forwarding snoop flow from a home agent of the data processing network and a locally cached MECID of a snoopee agent of the data processing network and responsive to the MECID mismatch detection, the snoopee agent downgrading the forwarding snoop flow to a non-forwarding snoop flow and providing a mismatch indication of the MECID mismatch to the home agent.

In any of the method embodiments, the forwarding snoop flow is a flow of a direct cache transfer (DCT).

In any of the method embodiments, the method further including the snoopee agent directly providing requested data to a requester agent when there is not a MECID mismatch.

In any of the method embodiments, the snoopee agent responsively downgrading the forwarding snoop flow to the non-forwarding snoop flow includes the snoopee agent providing to the home agent data requested by a requester agent of the data processing network, together with a cached MECID of the snoopee agent and the mismatch indication of the MECID mismatch between a value of the cached MECID and a value of an incoming MECID from the requester agent.

In any of the method embodiments, the method further including the home agent taking action responsive to receiving the mismatch indication, said action attributable at least in part to a physical address space (PAS) associated with the home agent.

In any of the method embodiments, where the home agent is a home agent of a non-secure protected PAS or a system agent PAS that has received the mismatch indication provided by the snoopee agent when the incoming MECID from the requester agent is mismatched from the cached MECID and the action by the home agent includes one or more of:
overwriting the cached data;
performing a write back of the requested data cached by the snoopee agent to a memory using the cached MECID and reading from memory with a new MECID;
dropping a clean line from the snoopee agent and reloading the dropped line from a memory with a new MECID; and
invalidating data of other requester agents of the network that correspond to the cached data of the snoopee agent.

In any of the method embodiments, where the home agent is a home agent of a realm physical address space (PAS) that is a protected VM execution environment, the home agent optionally providing plaintext data to the requester agent when the incoming MECID from the requester agent is mismatched from the cached MECID, as indicated by the mismatch indication provided by the snoopee agent to the home agent.

In any of the method embodiments, the method further including the home agent invalidating cached copies of requested data responsive to receiving the mismatch indication of the mismatch between the value of the cached MECID and the value of the incoming MECID from the requester agent.

In any of the method embodiments, where the snoopee agent responsively downgrading the forwarding snoop flow to the non-forwarding snoop flow includes the snoopee agent providing the requested data to the home agent and further not providing the requested data to the requester agent.

In any of the method embodiments, the method further including the requester agent not changing how data is requested independent of a physical address space (PAS) that is accessed for data.

In any of the method embodiments, where the PAS is one or more of a realm PAS, a system agent PAS and a non-secure protected PAS.

In any of the method embodiments, the method further including the snoopee agent detecting when there is a mismatch between a value of a cached MECID of the snoopee agent and a value of an incoming MECID from a requester agent.

In any of the method embodiments, where the mismatch indication of the mismatch between the cached MECID and the incoming MECID is detected by the snoopee agent performing a comparison of the cached MECID and the incoming MECID.

In one embodiment, an apparatus including a snoopee agent of a data processing network that is configured to respond to detection of a memory encryption context identification (MECID) mismatch between a MECID of an incoming snoop and a locally cached MECID of the snoopee agent by responsively downgrading a forwarding snoop flow of the incoming snoop to a non-forwarding snoop flow.

In any of the apparatus embodiments, where the snoopee agent is further configured such that, responsive to detection of the memory encryption context identification (MECID) mismatch between the incoming snoop and the locally cached MECID, the snoopee agent additionally provides a mismatch indication of the MECID mismatch to a home agent of the data processing network.

In any of the apparatus embodiments, the snoopee agent is further configured such that when there is not a MECID mismatch, the snoopee agent directly provides requested data to a requester agent of the data processing network.

In any of the apparatus embodiments, where the snoopee agent is configured to responsively downgrade the forwarding snoop flow to the non-forwarding snoop flow with the snoopee agent configured to provide the requested data to the home agent and further to not provide the requested data to a requester agent.

In any of the apparatus embodiments, where the snoopee agent is configured to responsively downgrade the forwarding snoop flow to the non-forwarding snoop flow with the snoopee agent configured to provide to a home agent of the data processing network data requested by a requester agent of the data processing network, together with a cached MECID of the snoopee agent and the mismatch indication of the MECID mismatch between a value of the cached MECID and a value of an incoming MECID from the requester agent.

In any of the apparatus embodiments, where the home agent is further configured to take action responsive to receiving the mismatch indication, said action attributable at least in part to a physical address space (PAS) associated with the home agent.

In any of the apparatus embodiments, where the home agent is a home agent of a non-secure protected PAS or a system agent PAS that has received the mismatch indication provided by the snoopee agent when the incoming MECID from the requester agent is mismatched from the cached MECID, the action by the home agent includes one or more of:
overwriting the cached data;
performing a write back of the requested data cached by the snoopee agent to a memory using the cached MECID and reading back from memory using a new MECID;
dropping a clean line from the snoopee agent and reloading the dropped line from a memory with a new MECID; and
invalidating data of other requester agents of the network that correspond to the cached data of the snoopee agent.

In any of the apparatus embodiments, where the home agent is a home agent of a realm physical address space (PAS) that is a protected VM execution environment and the home agent optionally provides plaintext data to the requester agent when the incoming MECID from the requester agent is mismatched from the cached MECID, as indicated by the mismatch indication provided by the snoopee agent to the home agent.

In any of the apparatus embodiments, where the home agent is further configured to invalidate cached copies of requested data responsive to receiving the mismatch indication of the mismatch between the value of the cached MECID and the value of the incoming MECID from the requester agent.

In any of the apparatus embodiments, where the snoopee agent is further configured to detect when there is a mismatch between a value of a cached MECID of the snoopee agent and a value of an incoming MECID from a requester agent.

In any of the apparatus embodiments, where the snoopee agent is further configured to detect the mismatch indication of the mismatch between the cached MECID and the incoming MECID by performing a comparison of the cached MECID and the incoming MECID.

In any of the apparatus embodiments, including a non-transitory computer-readable medium storing computer-readable code for fabrication of the apparatus described above.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises ...a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added or operations can be deleted without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioral representations of the concepts that can be interpreted by a computer to enable simulation, functional and/or formal verification, and testing of the concepts.

Additionally, or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively, or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively, or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

What is claimed is:

1. A method, comprising:
detecting in a data processing network of a memory encryption context identification (MECID) mismatch between a MECID of an incoming snoop of a forwarding snoop flow from a home agent of the data processing network and a locally cached MECID of a snoopee agent of the data processing network and responsive to the MECID mismatch detection, the snoopee agent downgrading the forwarding snoop flow to a non-forwarding snoop flow and providing a mismatch indication of the MECID mismatch to the home agent.

2. The method of claim 1, where the forwarding snoop flow is a flow of a direct cache transfer (DCT).

3. The method of claim 1, further comprising the snoopee agent directly providing requested data to a requester agent when there is not a MECID mismatch.

4. The method of claim 1, where the snoopee agent responsively downgrading the forwarding snoop flow to the non-forwarding snoop flow includes the snoopee agent providing to the home agent data requested by a requester agent of the data processing network, together with a cached MECID of the snoopee agent and the mismatch indication of the MECID mismatch between a value of the cached MECID and a value of an incoming MECID from the requester agent.

5. The method of claim 4, further comprising the home agent taking action responsive to receiving the mismatch indication, said action attributable at least in part to a physical address space (PAS) associated with the home agent.

6. The method of claim 5, where the home agent is a home agent of a non-secure protected PAS or a system agent PAS that has received the mismatch indication provided by the snoopee agent when the incoming MECID from the requester agent is mismatched from the cached MECID and the action by the home agent includes one or more of:
overwriting the cached data;
performing a write back of the requested data cached by the snoopee agent to a memory using the cached MECID and reading from memory with a new MECID;
dropping a clean line from the snoopee agent and reloading the dropped line from a memory with a new MECID; and
invalidating data of other requester agents of the network that correspond to the cached data of the snoopee agent.

7. The method of claim 5, where the home agent is a home agent of a realm physical address space (PAS) that is a protected VM execution environment, the home agent optionally providing plaintext data to the requester agent when the incoming MECID from the requester agent is mismatched from the cached MECID, as indicated by the mismatch indication provided by the snoopee agent to the home agent.

8. The method of claim 4, further comprising the home agent invalidating cached copies of requested data responsive to receiving the mismatch indication of the mismatch between the value of the cached MECID and the value of the incoming MECID from the requester agent.

9. The method of claim 4, where the snoopee agent responsively downgrading the forwarding snoop flow to the non-forwarding snoop flow includes the snoopee agent providing the requested data to the home agent and further not providing the requested data to the requester agent.

10. The method of claim 4, further comprising the requester agent not changing how data is requested independent of a physical address space (PAS) that is accessed for data.

11. The method of claim 1, further including the snoopee agent detecting when there is a mismatch between a value of a cached MECID of the snoopee agent and a value of an incoming MECID from a requester agent.

12. An apparatus comprising:
a snoopee agent of a data processing network that is configured to respond to detection of a memory encryption context identification (MECID) mismatch between a MECID of an incoming snoop and a locally cached MECID of the snoopee agent by responsively downgrading a forwarding snoop flow of the incoming snoop to a non-forwarding snoop flow.

13. The apparatus of claim 12, where the snoopee agent is further configured such that, responsive to detection of the memory encryption context identification (MECID) mismatch between the incoming snoop and the locally cached MECID, the snoopee agent additionally provides a mismatch indication of the MECID mismatch to a home agent of the data processing network.

14. The apparatus of claim 12, the snoopee agent is further configured such that when there is not a MECID mismatch, the snoopee agent directly provides requested data to a requester agent of the data processing network.

15. The apparatus of claim 12, where the snoopee agent is configured to responsively downgrade the forwarding snoop flow to the non-forwarding snoop flow with the snoopee agent configured to provide the requested data to the home agent and further to not provide the requested data to a requester agent.

16. The apparatus of claim 12, where the snoopee agent is configured to responsively downgrade the forwarding snoop flow to the non-forwarding snoop flow with the snoopee agent configured to provide to a home agent of the data processing network data requested by a requester agent of the data processing network, together with a cached MECID of the snoopee agent and the mismatch indication of the MECID mismatch between a value of the cached MECID and a value of an incoming MECID from the requester agent.

17. The apparatus of claim 12, where the home agent is further configured to take action responsive to receiving the mismatch indication, said action attributable at least in part to a physical address space (PAS) associated with the home agent.

18. The apparatus of claim 17, where the home agent is a home agent of a non-secure protected PAS or a system agent PAS that has received the mismatch indication provided by the snoopee agent when the incoming MECID from the requester agent is mismatched from the cached MECID, the action by the home agent includes one or more of:
overwriting the cached data;
performing a write back of the requested data cached by the snoopee agent to a memory using the cached MECID and reading back from memory using a new MECID;
dropping a clean line from the snoopee agent and reloading the dropped line from a memory with a new MECID; and
invalidating data of other requester agents of the network that correspond to the cached data of the snoopee agent.

19. The apparatus of claim 17, where the home agent is a home agent of a realm physical address space (PAS) that is a protected VM execution environment and the home agent optionally provides plaintext data to the requester agent when the incoming MECID from the requester agent is mismatched from the cached MECID, as indicated by the mismatch indication provided by the snoopee agent to the home agent.

20. A non-transitory computer-readable medium storing computer-readable code for fabrication of the apparatus of claim 12.
